(19) United States
(12) Patent Application Publication
(10) Pub. No.: US 2021/0260788 A1
(43) Pub. Date: Aug. 26, 2021

(54) PARAFFIN-REINFORCED WOOD AND METHOD FOR MANUFACTURING THE SAME

(71) Applicant: GL ONE CO., LTD., Chungcheongnam-do (KR)

(72) Inventors: Man Serb JEONG, Chungcheongnam-do (KR); Du Sun JANG, Chungcheongnam-do (KR)

(21) Appl. No.: 16/627,598

(22) PCT Filed: Sep. 7, 2018
(86) PCT No.: PCT/KR2018/010498

§ 371 Date: Dec. 30, 2019

(51) Int. Cl. B27K 3/08; B27K 3/34

(52) U.S. Cl. CPC B27K 3/08; B27K 3/34

(57) ABSTRACT

The present invention provides a paraffin-reinforced wood and a method for manufacturing the same, and more specifically, a paraffin-reinforced wood in which a natural wood is vacuum impregnated with dissolved paraffin and processed, thereby preventing a penetration of moisture into the wood and increasing durability and corrosion resistance of the wood, such that the reinforced wood is very useful as various deck-wood, agricultural wood posts, water wood posts, etc., and a method and apparatus for manufacturing the same.

### FIELD OF THE INVENTION

The present invention relates to a paraffin-reinforced wood and a method for manufacturing the same, and more specifically, to a paraffin-reinforced wood in which a natural wood is vacuum impregnated with dissolved paraffin and processed, thereby preventing a penetration of moisture into the wood and increasing durability and corrosion resistance of the wood, such that the reinforced wood is very useful as various deck-wood, agricultural wood posts, water wood posts, etc. The present invention relates to a method and apparatus for manufacturing environmentally friendly paraffin-reinforced wood.

### BACKGROUND

Wood has advantages of light weight and processing facilitation, such that it is recognized as the most eco-friendly material used in various structures. However, on the other hand, there is a limit to procurement because it is a natural material, and despite its many advantages, it is weak to moisture and easy to rot, such that resistance and stiffness of the wood are not so strong. Thus, there is a limit for use in an economic aspect, and there are also drawbacks as a material such as a difficulty in applying to a structure that needs to be maintained for along period of time.

Although wood has problems entailed in the material, the wood is one of the most preferred materials for the structure.

Therefore, various techniques for extending a service life of such a wood are applied in the art. The representative technique of preservative treatment techniques for extending the service life of wood is a preservative treatment technique of railroad ties, which has long been widely used. In the case of railroad ties, techniques such as a creosote oil pressure impregnation method and use of sterile antiseptic solution containing heavy metals have been applied. In addition, a technique for processing the wood with various oil ingredients such as linseed oil has been proposed as a similar method.

However, when treating the wood using the wood processing technique such as railroad ties or various oil ingredients, the service life of wood can be extended for a considerable period of time, but secondary environmental pollution occurs due to the substances applied to the processing, and this leads to water pollution caused by environmental pollutants. Therefore, in recent years, the use of such a processing substance is prohibited, and the treatment method using the oil ingredients also shows a limit.

Due to the above-described problems, a new processing technique for wood has emerged, and since the processing by using the antiseptic impregnation liquid is prohibited, various techniques for treating the surface of wood has been proposed as a new technique to replace the above processing.

As a surface treatment technique of wood, a great variety of methods have been proposed and studied, such as coating the wood surface with a paint, thermal compression treatment, and high-temperature thermal treatment method, as well as methods of injecting various resins such as water-soluble melamine or epoxy resin, water-soluble acrylic resin, polyester resin, etc., into a wood tissue, followed by curing the same. Actual products are developed and produced based on the manufacturing technique of such the processed wood.

Among them, recently, as a method for processing wood, a number of synthetic wood manufacturing techniques using wood by-products rather than the natural wood have also been proposed. Products prepared by mixing wood flours with polypropylene or polyethylene have been commercialized as a substitute for preserved wood, and are widely used as a deck wood for outdoor facilities. Such synthetic wood products compensate for disadvantages of natural wood which is vulnerable to heat, humidity, bending and distortion, while maintaining a texture similar to that of the natural wood Therefore, practical use of the synthetic wood products as a material having a natural wood texture has been widely spread, and has been in the spotlight in terms of recycling the natural wood by-products or as the substitute for durable woods.

However, despite an expansion in application fields of these synthetic woods, a problem that the product is easily bent or distorted still remains, and in particular, there is also an environmental problem caused by chemical substances. Therefore, it is difficult for the synthetic woods to be widely applied to all structures, and in particular, there is a problem that they cannot be used as wood posts for ginseng cultivation or other agricultural wood posts, which are related to the real life.

Conventionally, as a method for processing the natural wood, Korean Patent Laid-Open Publication No. 10-2003-0076535 discloses a method for forming wood grains on a wooden board using paraffin, which is characterized by including a surface coating process of applying paraffin to a surface of the wooden board that has been polished. In addition, Korean Patent Registration No. 10-0650347 discloses a technique of coating a frame wood for a cargo box of a commercial truck with a paraffin solution to form a coating film on the surface and the inside of the frame wood for a cargo box of the commercial truck, thereby blocking the penetration of moisture into the wood resulting from a change of humidity and dryness in the atmosphere, thus to improve durability of the wood surface and extend the functional life of the wood.

However, such wood processing techniques can obtain some life extension effects by surface treatment of the wood, but there is a limit to obtain preservative effects due to an inherent nature of the wood. In addition, a problem of failing to achieve an improvement in intrinsic durability still remains, and an improvement in this regard is required.

Further, a development of new processing technique that can improve the durability of wood by processing the natural wood in an eco-friendly manner, which is useful for deck wood or agricultural wood posts is urgently required.

### CITED DOCUMENTS

### Patent Documents

(Patent Document 1) Korean Patent Laid-Open Publication No. 10-2003-0076535

(Patent Document 2) Korean Patent Registration No. 10-0650347

### SUMMARY OF THE INVENTION

In order to meet the above-described problems of the prior art and improvement requirements, it is a purpose of the present invention to provide a new wood processing technique to basically improve durability of wood in an eco-friendly manner beyond a simple surface treatment of the conventional processing technique for natural wood, and a reinforced wood manufactured by the technique.

Accordingly, it is an object of the present invention to provide a paraffin-reinforced wood having anew configuration with improved durability and strength by completely penetrating paraffin, which is a durable antiseptic material, to an inside of the wood.

In addition, another object of the present invention is to provide a method for manufacturing a paraffin-reinforced wood, in which a natural wood is vacuum impregnated with dissolved paraffin to prevent a penetration of moisture into the wood and increase the durability and corrosion resistance of wood, in order to manufacture an eco-friendly processed wood having enhanced durability.

Further, another object of the present invention is to provide an eco-friendly agricultural wood post made of the paraffin-reinforced wood as described above.

In order to achieve the above objects, the present invention provides a paraffin-reinforced wood, wherein a natural wood, from which moisture, organic acid-containing cellulose, and volatile components are substantially removed by vacuum treatment, is impregnated with paraffin, and the paraffin is impregnated in an entire internal tissue of the wood including pores inside the wood.

In addition, the present invention provides a method for manufacturing a paraffin-reinforced wood including the steps of cutting a natural wood; performing preheat treatment on the cut wood and dying the same; performing vacuum treatment on the dried wood by introducing it into a vacuum chamber; injecting dissolved liquid paraffin into a vacuum chamber to impregnate the vacuum-treated wood with the paraffin; and taking-out the paraffin-impregnated wood and cooling the same.

Further, the present invention provides an apparatus for manufacturing a paraffin-reinforced wood, which is a manufacturing apparatus of the paraffin-reinforced wood as described, including a vacuum chamber, a paraffin boiler and a vacuum pump, wherein the vacuum chamber has an internal space for vacuum impregnating the wood with paraffin and is connected to the vacuum pump, the paraffin boiler is connected with an injection line capable of injecting a paraffin solution into the vacuum chamber and a discharge line for discharging the paraffin solution remaining in the vacuum chamber after the impregnation, and includes a paraffin heating means for liquefying the paraffin by heating to a molten state, and the vacuum pump includes a structure connected to the vacuum pump so as to be operated by adjusting the vacuum state in the vacuum chamber.

Furthermore, the present invention provides an eco-friendly agricultural wood post made of the paraffin-reinforced wood prepared as described above.

The paraffin-reinforced wood according to the present invention is excellent in durability and strength, and in particular eco-friendly unlike the conventional surface treated or oil-impregnated wood, such that it can be widely used in various deck woods, outdoor structures, agricultural wood posts and the like.

In particular, the paraffin-reinforced wood according to the present invention is prepared by drying and performing vacuum treatment to remove moisture or volatile components from the wood, and the paraffin is impregnated in the pores thereof, such that the durability is superior to that of the existing wood, as well as the strength is also excellent, and thereby it is long lasting when exposed to the outdoor environment, water, soil and the like. In addition, the inventive wood is processed with eco-friendly components that are harmless to the human body, thus it is applicable to a new material that can be used very well for agricultural and industrial structures such as wood posts for ginseng cultivation that need to withstand environmental conditions for along period time.

Further, according to the present invention, it is a natural friendly technique that can maintain a demand for wood for a long period of time while improving the existing environmental problems by providing such an eco-friendly wood, thereby it is possible to greatly contribute to forestry promotion.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is photographs and partial enlarged photographs showing wood surfaces for comparison between test specimens of a wood before impregnation with paraffin and a paraffin-reinforced wood after vacuum impregnation according to the present invention;

FIGS. 2A and 2B are microphotographs showing a test specimen of a wood before the impregnation with paraffin (FIG. 2A) and microphotographs showing a test specimen of paraffin-reinforced wood after the vacuum impregnation according to the present invention (FIG. 2B); and

FIG. 3 is a schematic view showing an apparatus for manufacturing a paraffin-reinforced wood according to the present invention.

### DETAILED DESCRIPTION

Hereinafter, the present invention will be described in more detail as one embodiment.

Unless otherwise defined, all technical and scientific terms used in the present disclosure have the same meaning as commonly understood by one of ordinary skill in the art to which the present invention belongs.

In the present disclosure, unless explicitly described to the contrary, the word “comprise” will be understood to imply the inclusion of other elements in addition to the stated element but not the exclusion of the other elements.

In the present invention, the expression “paraffin is impregnated in the entire internal tissue of a wood including pores inside the wood” means a phenomenon in which the paraffin penetrates throughout the entire space inside the wood from which moisture and the like are removed in the vacuum-treated state, such that impregnation of the paraffin is wholly performed on not only the surface of the wood but also the inside of the wood.

The present invention may greatly improve the surface treatment technique of wood for increasing utilization of natural wood, and newly improve physical properties of natural wood such as durability by vacuum impregnating the natural wood with paraffin which is an eco-friendly material, thereby greatly increasing the utilization of wood by maintaining the physical properties and eco-friendliness of the wood even when using it for a long period of time.

Generally, paraffin wax used in the present invention is obtained by dewaxing a lubricative petroleum raw material, and is used as candles, wax papers, varnishes, cosmetics, electrical insulators and the like. The paraffin wax helps extracting fragrances from flowers, is a major component of medical ointments, and is also used as a waterproofing paint for wood. Paraffin extensively refers to alkane hydrocarbons represented by a formula CₙH₂ₙ₊₂ (n≥19), and is insoluble in water but soluble in ether, benzene and ester. Paraffin is a mixture of hydrocarbon molecules consisting of 20 or 40 carbon molecules, and is a white, colorless, soft solid derived from petroleum, coal, or oil shale. Solid paraffin is referred to as paraffin wax.

Such paraffin wax is not digested or absorbed in the human body, and as a result of various toxicology experiments, most of the paraffin wax is not toxic, and in a specific case, a slight degree of toxicity is shown, such that it is known as an eco-friendly material. The paraffin wax is a representative water-insoluble, colorless and odorless material, and has a boiling point of about 370° C. or higher and a melting point of about 50-57° C. with being in a solid at room temperature, such that it does not melt well under normal outdoor conditions.

As described above, when impregnating a wood with the paraffin used in the present invention, there is no risk of contaminating the surroundings because it is solid at room temperature. In addition, since it is known as a non-toxic material, the vacuum-impregnated wood with such a paraffin may be used as an eco-friendly wood. In particular, the paraffin-reinforced wood is very suitable for use in agricultural wood posts, such as wood posts for ginseng cultivation, which are highly sensitive to toxicity and require durability, processability, workability, etc. in a state of being exposed to a climatic environment.

According to the preferred embodiment of the present invention, the paraffin impregnated in the natural wood are penetrated entirely into the pores formed in the wood by vacuum impregnation in the dissolved state to be present to a core of the wood, thereby being substantially present in the entire volume of the wood.

According to the preferred embodiment of the present invention, the wood is dried in order to allow the paraffin to penetrate into the wood, and then is subjected to vacuum treatment, thus to remove moisture, organic acid-containing cellulose and volatile components such as pyroligneous liquor, which are present in the wood. Next, liquid paraffin is vacuum-impregnated into the pores inside the wood, which are formed by removing the moisture, etc. as described above, to manufacture a wood with the paraffin penetrated into the pores. Therefore, after the vacuum impregnation, the paraffin is substantially impregnated throughout the entire of respective tissues inside the wood.

According to the preferred embodiment of the present invention, although it is different depending on types of wood used as natural wood, the paraffin-reinforced wood of the present invention may contain paraffin in an amount of 2.0-50.0% by weight in the impregnated wood. If the content of the paraffin is too small, it is difficult to achieve the objects of the present invention because the durability, etc., is not good, and if the content thereof is too large, water resistance and preservative effects are excellent, whereas the strength of the wood may be lowered, such that it is difficult to perform impregnation injection in the manufacturing process, and thus it is not preferable. The impregnation amount of such paraffin may vary depending on the types of wood, due to its cellular properties or shape. Preferably, in the case of natural wood of conifers, it is possible to contain the paraffin in a smaller amount than the hardwood in terms of the properties of the wood.

According to the preferred embodiment of the present invention, as such a natural wood used in the present invention, generally, it is possible to employ all the wood that can be used as a square wood bar.

Examples of the wood that can be used in the present invention include larch, pine, oak, apitong, New Zealand pine, radiata pine and the like, and these are preferably applicable to the present invention.

According to the preferred embodiment of the present invention, the paraffin-reinforced wood prepared by impregnating the natural wood with paraffin can be manufactured by the following processes.

First, a natural wood for processing is subjected to the step of selecting and cutting.

Such the cut wood may be manufactured in a conventional method by defining a size according to the application as various products such as a square wood bar, cylindrical wood, board-shaped wood having a constant thickness, etc., and may be typically processed into the square wood bar. The wood can be cut, for example, from several tens of millimeters to several hundreds of millimeters, but if the thickness is too thick, it takes too much time for vacuum and impregnation treatments, thus it is not preferable. Preferably, the cut wood has a thickness of about several tens of millimeters, and most preferably, for example, about 10-50 mm.

According to the preferred embodiment of the present invention, it is preferable to vacuum-impregnate the wood with a low moisture content by drying before or after the fabrication of the cut wood.

If performing vacuum treatment on a wood containing a lot of moisture as it is, since a large amount of moisture and volatile components should be vacuum-removed at once, many difficulties may occur in the vacuum treatment. Therefore, most of all, it is preferable to use a dried wood as the processed wood by bringing the moisture content of the wood to about 8-15% by weight or less through drying.

The cut wood as described above is dried to some extent, but prior to the vacuum treatment, it is preferable to first perform the step of preheating and drying the cut wood.

Herein, the reason for preheating the dried and cut wood is to facilitate the vacuum treatment. At this time, it is preferable that the preheat treatment is performed at a temperature condition of 100-200° C., and more preferably 110-130° C. for 2-10 hours, so as to dry well to the core of the wood. If the temperature of preheat treatment is too low, an impregnation amount of a paraffin solution is lowered by various gases generated inside the wood, and if the temperature thereof is too high, workability is deteriorated or it is economically disadvantageous due to unnecessary heating conditions.

In addition, it is preferable that the preheated wood is subjected to the vacuum treatment immediately before cooling.

According to the preferred embodiment of the present invention, the dried wood subjected to heat treatment is introduced into a vacuum chamber, followed by vacuum treating, thus vacuum treatment on the wood is completed via this step.

According to the preferred embodiment of the invention, the vacuum treatment is preferably performed under conditions of a vacuum level of about 0.01-5.0 torr, and more preferably 0.1-1.0 torr. When performing the vacuum treatment as described, all of the residual moisture contained in the wood is substantially removed. In addition to the moisture, all the organic acid-containing cellulose and various volatile components such as pyroligneous liquor may be removed. For performing such a treatment, it is preferable to maintain this state for about 3-20 minutes, and more preferably about 5-10 minutes while maintaining the above-described vacuum level.

Meanwhile, the paraffin may be prepared in advance in a solution phase by separately preparing the paraffin wax to be injected into the wood, and dissolving by performing heat treatment.

According to the preferred embodiment of the present invention, the inventive method includes the step of impregnating the wood with paraffin by injecting the dissolved liquid paraffin into the vacuum-treated wood.

According to the preferred embodiment of the present invention, such an impregnation process of paraffin into the wood may be performed by injecting the paraffin into the vacuum chamber in a vacuum suction method, or by injecting the paraffin in a pressure method using a separate paraffin transfer pump, so as to be impregnated into the wood. In this process, the vacuum suction may be performed while maintaining the vacuum level in the above-described range or more.

In addition, it is preferable to maintain the temperature within the above-described range as it is.

According to the preferred embodiment of the present invention, the paraffin in a solution phase used herein may be impregnated to the inner core of the wood by injecting liquid paraffin at a temperature of 100-150° C., and more preferably 110-125° C. Paraffin wax has a dissolution temperature of 43-95° C. in a solid state, but if the temperature is too low at the time of dissolution, the viscosity thereof is too large, such that it is difficult to perform the vacuum impregnation, and if the temperature is too high, workability is deteriorated and unnecessary energy is consumed, thus it is not preferable.

The vacuum chamber and a melting furnace for dissolving the paraffin wax used herein may be provided with an exhaust system at an outside, and a means for condensing the paraffin wax by cooling water or a cooler as a means installed to prevent a leakage of odor by harmful substances or volatile components in the melting furnace.

According to the preferred embodiment of the present invention, the paraffin-reinforced wood according to the present invention may be prepared by performing the steps of taking out and cooling the paraffin-impregnated wood subjected to the above-described processes of the inventive method. Herein, cooling is performed by a conventional method, and it is also possible to cool by maintaining normal temperature or performing low temperature treatment.

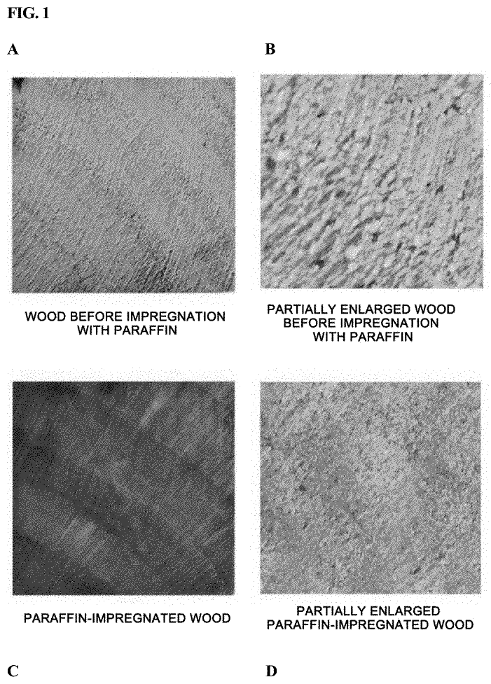

FIG. 1 is photographs presented for comparing the wood before and after treatment with paraffin by vacuum impregnation.

According to the preferred embodiment of the present invention, when impregnating a wood with paraffin wax, an impregnated capacity and an impregnated shape of the paraffin to be impregnated may be determined depending on the types of wood or the moisture content in the wood, preheating temperature, vacuum level, impregnation temperature, and impregnation time. Therefore, it may be configured so that the desired impregnation is possible by setting the conditions of the vacuum impregnation according to the application of the required product, as necessary.

In general, paraffin is a by-product of petrochemicals, which is cheaper than typical polymer materials, but sometimes more expensive than the wood. Therefore, in order to reduce costs, it is necessary to precisely adjust the impregnating capacity of paraffin so as to obtain the desired physical properties even using a minimum amount of paraffin.

According to the present invention, when vacuum impregnating the dried wood with paraffin, a vacuum impregnation rate is lowered as the moisture content increases, and is increased in proportion to the vacuum impregnation time. The impregnation amount of paraffin is increased in inverse proportion to the impregnation vacuum pressure.

Therefore, according to the preferred embodiment of the present invention, it is considered to be a very useful way to control an impregnation amount of the paraffin by adjusting the vacuum impregnation pressure. Accordingly, the present invention includes a method for manufacturing a paraffin-containing reinforced wood in a manner of controlling the impregnation amount of paraffin by adjusting the vacuum impregnation pressure.

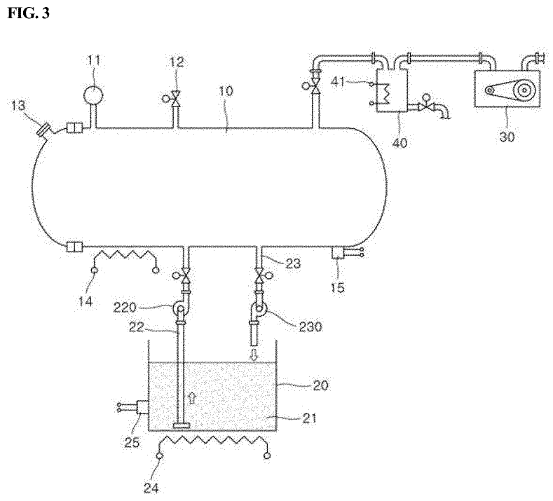

Meanwhile, the above-described apparatus for manufacturing a paraffin-reinforced wood according to present invention includes a vacuum chamber 10, a paraffin boiler 20 and a vacuum pump 30. Such an apparatus has components as shown in FIG. 3.

According to the preferred embodiment of the invention, the vacuum chamber 10 has an internal space for vacuum impregnation of wood, and is connected to the paraffin boiler 20 and the vacuum pump 30.

According to the preferred embodiment of the present invention, the vacuum chamber 10 includes a vacuum gauge 11 and a pressure control valve 12 installed therein to measure and adjust the vacuum level inside thereof, and if necessary, a view port 13 for observing the inside of the vacuum chamber 10 may be installed. In addition, the vacuum chamber 10 may include a chamber heating means 14 for raising a temperature inside of the vacuum chamber 10 and a chamber temperature sensor 15 capable of detecting the temperature inside thereof.

According to the preferred embodiment of the present invention, the paraffin boiler 20 is connected with an injection line 22 for injecting a paraffin solution 21 into the vacuum chamber 10 and a discharge line 23 for discharging the paraffin solution remaining in the vacuum chamber 10 after the impregnation, and includes a paraffin heating means 24 for liquefying the paraffin by heating to a molten state.

According to the preferred embodiment of the present invention, the paraffin boiler 20 may include a paraffin temperature sensor 25 for detecting a temperature of the molten paraffin, and a paraffin injection pump 220 and a paraffin discharge pump 230 may be installed in the injection line 22 and the discharge line 23, respectively. In addition, the paraffin boiler 20 may be provided with an internal circulation system for circulating the paraffin solution, for example.

The vacuum pump 30 includes a structure connected to the vacuum chamber 10 so as to be operated by adjusting the vacuum state inside the vacuum chamber 10. Herein, a condenser 40 having a cooling means 41 may be installed between the vacuum chamber 10 and the vacuum pump 30.

According to the present invention, in order to manufacture a paraffin-reinforced wood, the vacuum chamber 10 as described above is preheated, then a wood to be reinforced is put in the vacuum chamber 10, and is vacuum dried using the vacuum pump 30, and the paraffin solution 21 melted in the paraffin boiler 20 is injected into the vacuum chamber 10, thereby performing vacuum impregnation so that the paraffin solution penetrates into the dried wood.

The paraffin-reinforced wood according to the present invention prepared as described above is to be used only by drying a natural wood as it is, and performing the vacuum impregnation with only the paraffin. Therefore, the paraffin-reinforced wood does not contain other chemicals, and may be used for various applications as an environmental material, since the paraffin is an eco-friendly material that is harmless to the human body.

In particular, according to the preferred embodiment of the present invention, the paraffin-reinforced wood of the present invention is very resistant to the moisture, and has excellent preservative effects to exhibit superior durability and strength. The paraffin-reinforced wood of the present invention may maintain original functions of wood even when usually using for 20-30 years or more outdoors, and may also have a strength superior to the existing wood. In addition, since paraffin has a density of 0.79-0.94 g/cm³ and the density thereof is lower than that of water, the paraffin-reinforced wood has a lower weight than that of the existing natural wood before drying, and thereby there is no great inconvenience in operations such as transportation or installation.

As described above, the paraffin-reinforced wood manufactured according to the present invention is an eco-friendly natural processed wood which is very excellent in water resistance, corrosion resistance, durability, etc., and is harmless to the human body. Therefore, it is expected that the paraffin-reinforced wood may be widely used as a substitute for natural material in various structures using the existing natural wood, square wood bar, or deck wood having a board shape, and in particular, is very useful for water wood posts, and agricultural wood posts, and among them, wood posts for ginseng cultivation, etc.

According to the preferred embodiment of the present invention, in particular, when using as a wood post for ginseng cultivation, since the paraffin-reinforced wood has excellent durability compared to the existing wood post, it may be used for a long period of time comparable to a steel post structure. In particular, since the steel structure has a problem that it is vulnerable to typhoons, etc., whereas the reinforced wood of the present invention is eco-friendly wood that is not harmful to ginseng crops and has excellent durability and strength, utilization values thereof are very high.

In addition, when the paraffin-reinforced wood of the present invention is widely applied to various outdoor wood structures, boards, etc., the durability thereof is several times higher than that of the existing synthetic wood or surface-coated wood, and it is possible to maintain natural texture as it is. Therefore, the paraffin-reinforced wood may be applied as a substitute for natural materials, such as outdoor structures, square wood bars, or board-shaped deck wood, and it is expected that the scope of use is very wide.

As described above, according to the present invention, it is expected that the paraffin-reinforced wood will have significant effects on the forestry and environmental effects as well as economic aspects as follows.

1) Currently, preserved woods cause great harm to the environment and the human body due to heavy metals contained therein, but according to the present invention, it is possible to manufacture a reinforced wood as an eco-friendly material, while allowing to be used as the reinforced wood having excellent preservative effects and durability. Therefore, it is possible to maintain the natural environment, harmless to the human body, and free from the worry of environmental pollution.

2) In an environment where climate change and environmental destruction are getting worse due to excessive logging of wood, the durability of wood is improved due to the birth of the reinforced wood according to the present invention. Thus, it is possible to reduce the logging of wood and preserve forests thus to contribute to global environmental protection.

3) Synthetic wood does not rot when discarded after use, and when incinerating it, toxic gases are emitted to cause environmental pollution. However, when using the reinforced wood of the present invention, semi-permanent use is possible, and even if discarding, it is possible to dispose in the same manner as ordinary natural wood to reduce the environmental damage.

4) For example, the wood posts for ginseng cultivation have to be replaced from time to time because they lack durability, and the industry has to depend on imports of more than 50 billion won annually for repurchasing costs, as well as the deck wood lacks durability, such that a lot of foreign currency is wasted due to imports of wood every year in Korea. However, when using the reinforced wood of the present invention, the use of pure domestic wood may replace the imported wood, or low-priced wood may be imported, and then, after impregnation treatment with paraffin according to the present invention, it is possible to reversely export the reinforced wood at a high price to greatly contribute to the national economy.

5) In the past, the price of imported wood or synthetic wood is high, which put a heavy burden on consumers. However, in the present invention, since a product having excellent durability is available at a lower price than the existing imported wood or synthetic wood, economic effects are very large.

6) Since woods produced in Korea have low durability, use efficiency thereof is low in many cases. However, when using the reinforced wood of the present invention, a low-cost wood is changed to a high-value wood after impregnation treatment with paraffin, such that it is possible to greatly contribute to the utilization of domestic forestry resources.

Hereinafter, the present invention will be described in detail based on examples, but the present invention is not limited to these examples.

### EXAMPLES

### Examples 1-4: Preparation of Paraffin-Reinforced Wood

As raw materials, four types of wood including larch, oak, apitong, and New Zealand pine were used.

The woods were cut into a square wood bar having a size of 33 mm width×33 mm height×2.4 m length, respectively.

Each processed square wood bar, which had a moisture content of 8% by weight or less, was used by naturally drying, and before putting into a vacuum chamber, was first dried for 3 hours at 150° C. in a heat treatment dryer to perform preheat treatment.

The weights of the preheated woods were measured, and the woods were transferred to a vacuum chamber preheated to 120° C. before cooling the preheated woods, followed by vacuum exhausting by operating a vacuum pump until a vacuum level in a vacuum system became 0.1-0.7 torr. In this state, the vacuum state was maintained for 10 minutes to remove all the moisture, organic acid-containing cellulose and volatile components such as pyroligneous liquor. Herein, the exhaust time was adjusted depending on the types of the wood to remove all the moisture, etc. from inside the wood.

Separately prepared paraffin wax was dissolved in a melting furnace at 120° C. so that all the wood was submerged in a paraffin solution by using a transfer pump in the solution state, and the vacuum pump was continually operated to exhaust the gas remaining in the wood for 30 minutes to be deformed.

Thereafter, air was injected into a vacuum chamber at a high pressure for 20 seconds to 1 minute in a closed state to impregnate the dried woods with the paraffin solution up to the core where pores exist inside thereof.

After the impregnation was completed, the paraffin was discharged from the vacuum chamber, the vacuum chamber was opened, and the paraffin-impregnated woods were taken out and cooled to prepare paraffin-reinforced woods.

Weights of the prepared paraffin-reinforced wood were measured to determine weights of the impregnated paraffin, and the measured results of the physical properties thereof are shown in Table 1 below.

### Comparative Examples 1-2

In order to compare with the above examples, apitong wood was prepared under the same conditions and dried, then the physical properties were measured as it was (Comparative Example 1), or the wood was impregnated with the paraffin solution dissolved as described above as it was without the vacuum state, followed by cooling and drying the same to prepare a paraffin-impregnated wood (Comparative Example 2). The measured results of the physical properties of the prepared woods are shown in Table 1 below. From these results, although it depends on the types of wood having different tissue structures from each other, it can be seen that the paraffin penetrates only the surface to coat the same, rather than deeply penetrates up to the inside of the wood by vacuum impregnation.

TABLE 1

| | | | | Impregnation |
|---|---|---|---|---|
| | | Vacuum | Preheating | amount of |
| | | level | temperature | paraffin (% by |
| Examples | Wood | (torr) | (° C.) | weight) |
| Example 1 | Larch | 0.3 | 120 | 5 |
| Example 2 | Oak | 0.5 | 120 | 18 |
| Example 3 | Apitong | 0.5 | 120 | 25 |
| Example 4 | New Zealand | 0.7 | 120 | 45 |
| | pine | | | |
| Comparative | Apitong | Untreated | — | — |
| Example 1 | | | | |
| Comparative | Apitong | Paraffin | — | 0.5 |
| Example 2 | | impregnated | | |

### Experimental Example 1

The impregnation amounts of paraffin according to the vacuum level were measured for the square wood bars (33 mm width×33 mm height×250 mm length) of apitong, New Zealand pine, oak, and larch, which are the wood specimens as described above. The measured results are shown in Table 2 below.

TABLE 2

| Vacuum level (torr) | | 1 torr or less | 10 torr | 100 torr | 300 torr |
|---|---|---|---|---|---|
| Impregnation | Apitong | 49 | 45 | 35 | 23 |
| amount of | New Zealand | 90 | 85 | 73 | 47 |
| paraffin (g) | pine | | | | |
| | Larch | 13 | 11 | 9 | 7 |
| | Oak | 46 | 41 | 31 | 22 |

As a result of the above experiment, all four species of wood were measured to have impregnation rates of paraffin inversely proportional to the vacuum pressure. From these results, it was confirmed that, when adjusting the vacuum impregnation pressure, the impregnation amount of paraffin could be adjusted.

### Experimental Example 2

Paraffin vacuum impregnation was performed on each wood specimen in the same manner as in the above examples, and the antiseptic effects were tested by comparing paraffin vacuum-impregnated woods and untreated woods for a comparative experiment.

Wood specimens used in this example were apitong and radiata pine, and an antiseptic effect test was performed by the KS M 1701 method. The test results are shown in Table 3 below.

TABLE 3

| | Test results | | |
|---|---|---|---|
| | | | Average weight |
| Test item | Test bacteria | Test subject | reduction rate (%) |
| Antiseptic | Fomitopsis | Apitong (impregnation | 0.40 |
| effect test | palustris | treated) | |
| (KS M | | Radiata pine (impregnation | 0.81 |
| 1701) | | treated) | |
| | | Radiata pine (untreated) | 24.14 |
| | Trametes | Apitong (impregnation | 0.00 |
| | versicolor | treated) | |
| | | Radiata pine (impregnation | 0.00 |
| | | treated) | |
| | | Radiata pine (untreated) | 34.48 |

From the results of the above Table 3, it was found that, when performing the paraffin vacuum impregnation treatment, there was almost no change in the content of the test bacteria, whereas the change in the content of the test bacteria in the untreated wood was very large. Therefore, from these antiseptic effect test results, it can be confirmed that the paraffin-impregnated reinforced woods are very excellent in durability and corrosion resistance compared to the existing untreated woods.

### Experimental Example 3

In order to confirm physical properties of the reinforced wood subjected to vacuum impregnation treatment on radiata pine with paraffin, a bending strength was measured by KS F 2208 method, which is a standard test method of the Korea Forestry Promotion Institute. As a result, the measured bending strength was 63.1 N/mm², which is much better than 30 N/mm² or more, which is the standard of bending strength for wood for installation of stairs (stair wood), where a common wood is used. Due to having these physical properties, the woods subjected to paraffin vacuum impregnation have excellent durability and corrosion resistance. In addition, it has been found that these woods could be applied to various facilities such as deck wood in terms of physical properties since they have rigidity higher than that of raw material wood.

### Experimental Example 4

Meanwhile, in order to identify a wood tissue before and after the paraffin impregnation, the states of the radiata pine before and after the impregnation were compared.

FIG. 1 is photographs and partial enlarged photographs showing wood surfaces for comparison between test specimens of radiata pine before impregnation with paraffin and a paraffin-impregnated reinforced wood after vacuum impregnation with paraffin according to the present invention. Herein, it can be seen that the reinforced wood subjected to vacuum impregnation with paraffin has a stronger wood structure than the wood before the impregnation when viewing the surface states thereof.

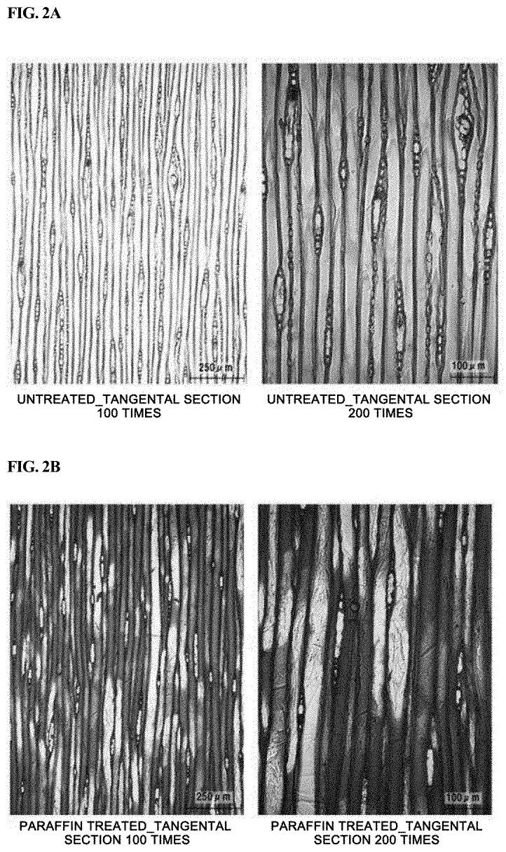

In addition, FIG. 2A is cross-sectional microphotographs showing a common radiata pine wood before the impregnation with paraffin, and FIG. 2B is cross-sectional microphotographs showing a tissue structure of paraffin-reinforced wood which is manufactured according to the example. These drawings show the impregnated state of the paraffin wax, in which the paraffin solution penetrates into the pore tissue of the wood as a whole to be hardened.

### DESCRIPTION OF REFERENCE NUMERALS

10: Vacuum chamber
11: Vacuum gauge
12: Pressure control valve
13: View port
14: Chamber heating means
15: Chamber temperature sensor
20: Paraffin boiler
21: Paraffin solution
22: Injection line
23: Discharge line
24: Paraffin heating means
25: Paraffin temperature sensor
220: Paraffin injection pump
230: Paraffin discharge pump
30: Vacuum pump
40: Condenser
41: Cooling means

What is claimed is:

1. A paraffin-reinforced wood comprising:
a natural wood from which moisture, organic acid-containing cellulose, and volatile components are removed by drying and vacuum treatment; and
paraffin impregnated into the natural wood,
wherein the paraffin is impregnated in an entire internal tissue of the natural wood including pores inside the natural wood.

2. The paraffin-reinforced wood according to claim 1, wherein the natural wood is a square wood bar.

3. The paraffin-reinforced wood according to claim 1, wherein the natural wood is any one of larch, pine, oak, apitong, New Zealand pine or radiata pine.

4. The paraffin-reinforced wood according to claim 1, wherein the paraffin is contained in the natural wood in an amount of 2.0-50.0% by weight.

5. A method for manufacturing a paraffin-reinforced wood according to claim 1, the method comprising the steps of:
cutting a natural wood;
performing preheat treatment on the cut wood and drying the same;
performing vacuum treatment on the dried wood by introducing it into a vacuum chamber;
injecting dissolved liquid paraffin into a vacuum chamber to impregnate the vacuum-treated wood with the paraffin; and
taking-out the paraffin-impregnated wood and cooling the same.

6. The method according to claim 5, wherein the preheat treatment is performed by drying for 2-10 hours under a condition of 100-150° C. so as to dry up to a core of the wood.

7. The method according to claim 5, wherein the vacuum treatment is performed at a vacuum level of 0.01-3.0 torr.

8. The method according to claim 5, wherein the step of impregnating the dried wood with the paraffin is performed by injecting the paraffin into the vacuum chamber in a vacuum suction method, or by injecting the paraffin in a pressure method using a separate paraffin transfer pump, so as to be impregnated into the wood.

9. The method according to claim 5, wherein the paraffin in a solution phase is liquid paraffin used at a temperature of 100-150° C.

10. The method according to claim 5, wherein the injecting step is performed by adjusting a vacuum impregnation pressure to control an impregnation amount of the paraffin.

11. An apparatus for manufacturing a paraffin-reinforced wood, the apparatus comprising:
a vacuum chamber; a paraffin boiler; and a vacuum pump,
wherein the vacuum chamber has an internal space for vacuum impregnating the wood with paraffin and is connected to the vacuum pump,
the paraffin boiler is connected with an injection line configured to inject a paraffin solution into the vacuum chamber and a discharge line configured to discharge the paraffin solution remaining in the vacuum chamber after the impregnation, and comprises a paraffin heating means configured to liquefy the paraffin by heating to a molten state, and
the vacuum pump comprises a structure connected to the vacuum pump so as to be operated by adjusting the vacuum state in the vacuum chamber.

12. The apparatus according to claim 11, wherein the vacuum chamber comprises:
a vacuum gauge and a pressure control valve installed therein to measure and adjust a vacuum level inside thereof;
a chamber heating means configured to raise a temperature inside of the vacuum chamber; and
a chamber temperature sensor configured to detect the temperature inside thereof.

13. The apparatus according to claim 11, wherein a paraffin injection pump and a paraffin discharge pump are installed in the injection line and the discharge line, respectively, which are connected to the paraffin boiler.

14. The apparatus according to claim 11, wherein a condenser including a cooling means is installed between the vacuum chamber and the vacuum pump.

15. An agricultural wood post comprising the paraffin-reinforced wood according to any one of claims 1 to 4.

16. The agricultural wood post according to claim 15, comprising a wood post for ginseng cultivation.

17. A deck wood comprising the paraffin-reinforced wood according to any one of claims 1 to 4.

18. The deck wood according to claim 17, comprising a deck wood formed in a board shape.
